(19) United States
(12) Patent Application Publication
(10) Pub. No.: US 2006/0137553 A1
(43) Pub. Date: Jun. 29, 2006

(54) Equipment for cleaning rubber cylinders of continuous printing machines

(76) Inventors: Marco Corti, Via Fornaci (IT); Riccardo Fumagalli, Via Baravico (IT)

Correspondence Address: STITES & HARBISON PLLC, 1199 NORTH FAIRFAX STREET, SUITE 900, ALEXANDRIA, VA, 22314, US

(21) Appl. No.: 10/562,985

(22) PCT Filed: Jul. 2, 2004
(86) PCT No.: PCT/EP04/07236

§ 371 Date: Dec. 29, 2005

(30) Foreign Application Priority Data
Jul. 11, 2003 (IT) GE2003A000050

(51) Int. Cl. B41F 35/00

(52) U.S. Cl. 101/425

(57) ABSTRACT

The equipment comprises means (17, 18) for causing a very small quantity of liquid for cleaning the said cylinders to be sprayed in a controlled and uniformly distributed way on to a sufficiently long portion of cloth, which, in the area directly acted on by the said sprayed liquids and in other areas, is kept in uniform and distributed contact with a transverse portion of the surface of the cylinder to be cleaned, and which is pushed, upstream and downstream of this portion, into close and uniformly distributed contact with the cylinder by a rectilinear deformable strip (6) and by a rectilinear deformable presser (9) respectively, each of these having an originally convex surface facing the cylinder, the whole being arranged in such a way that the cleaning liquid acts through the cloth on the cylinder to be cleaned in an extended, uniform and progressive way and in a very small quantity, and in such a way that the liquid is conveniently retained in the said cleaning area by the said cloth and the said rectilinear pressure elements, so that it does not fall off and so that it is transferred to the dirt on the cylinder in a gradual and controlled way, while the presser (9) facilitates the penetration of the liquid into the direct and promotes the elimination and removal of the said dirt. The active surface of the presser (9) has a suitable lowrelief configuration for better distribution of the cleaning liquid, to provide a better mechanical action for cleaning the cylinder and to retain in its channels (209) of originally outwardly diverging shape a large quantity of the paper particles which constitute the dirt removed from the cylinder.

The present invention relates in particular to continuous printing machines known as reel-fed machines because they are designed for printing a continuous web of paper unwound from a reel, the machines having rubber printing cylinders which act simultaneously on the opposite sides of the said continuous paper web. At present, the rubber cylinders of these machines are cleaned with devices which spray the cleaning liquid on to the cylinders, which are not inked at the time, and which are kept rotating and in contact with the continuous paper web which is used as a means for continuously cleaning the said cylinders. The liquid sprayed on the cylinders has the function of dissolving the dirt consisting of ink and paper particles, and the paper web has the function of removing the dissolved dirt by contact. This method operates correctly when the dirt accumulated on the cylinders is relatively fresh and very thin, but when the dirt has a considerable thickness there is a risk that it will combine with the cleaning liquid to form a sticky paste which both adheres strongly to the paper and remains strongly adhering to the cylinder, consequently tearing the paper web and breaking the continuity of the cleaning cycle. In the initial stages of the cleaning cycle, where a very small amount of dirt is present, the cleaning liquid tends to remain on the surface and is removed unnecessarily by the paper web, thus increasing the duration and cost of the cleaning cycle. This method also has the limitation of cleaning only the portion of the cylinders coming into contact with the continuous paper web, and not the edge areas and the areas beyond the surface in contact with the said paper, on which areas there is a tendency for lines known as format lines to develop.

To overcome the said drawbacks, attempts have been made to treat the rubber cylinders with devices currently used on other printing machines, for example those using a rotating cylindrical brush which is made to interfere in a parallel way with the cylinder and which is sprayed with cleaning liquid upstream of the area of contact with the said cylinder and made to interact with cleaning means downstream of this area. Attempts have also been made to use devices comprising a cloth sprayed with cleaning liquids and pushed by a presser against the cylinder. All these devices have been found unsuitable for use on the rubber cylinder positioned under the paper web, since the cleaning liquid sprayed upstream of the cleaning element which is in contact with the cylinder tends to drop off due to gravity. The said devices also require an excessive quantity of cleaning liquids in use, and are relatively slow and therefore unsuitable for use on printing machines during operation, while those of the second type require an excessive use of cleaning cloths, which have to be replaced frequently with corresponding stoppages of the machine.

To overcome the said drawbacks of the known art, there is also a known method in which a portion of cleaning cloth, under the correct tension, of a device of the last type mentioned above, drawn from a feed reel and connected to a take-up reel, these reels being suitably braked, is run around the front concave surface of a bar, on which surface the following are mounted, in order of interference with the direction of rotation of the cylinder to be cleaned and parallel to this cylinder: at least one strip of elastomeric material, which is in contact with the said portion of cloth; at least one row of nozzles for the continuous, fine and uniformly distributed spraying of cleaning liquid on to a portion of cloth positioned downstream of the said strip, the nozzles being kept at a suitable distance from the said cloth; and a presser with an insert of elastomeric material whose surface with an initially convex profile comes into contact with the cloth. The ends of the said bar are integral with the shoulders which the cloth feed and take-up reels usually have, and the whole assembly is designed to be moved on command in a parallel way towards or away from the cylinder to be cleaned. When the whole assembly is brought towards the cylinder to be cleaned, this cylinder continuing to move in contact with the paper web, the portion of cloth between the strip and the presser is stretched and curved in contact with the cylinder, and adheres uniformly to the said cylinder, so as to distribute and retain on the cylinder the cleaning liquid which is finely sprayed in a uniform, distributed and controlled way by the said row of nozzles. The soiled surface of the cylinder is thus subjected to the action of very small and uniformly distributed quantities of the cleaning liquid, which immediately reacts with the dirt on the cylinder and is subsequently removed with the dirt by the contact of the said cylinder with the continuously moving paper web. The liquid spraying nozzles are suitably distant from the cloth, and are therefore not affected by the dirt with which the said cloth comes into contact. The elastomeric strip which makes the cloth adhere to the area of the cylinder upstream of the row of liquid spraying nozzles (the terms “upstream” and “downstream” refer to the direction of rotation of the cylinders to be cleaned) brings the said cloth into contact with the cylinder with minimal pressure which is sufficient to keep the sprayed liquid in the operating area, while the elastomeric insert with the externally convex surface of the presser exerts a distributed pressure on the cloth, such that the cylinder is cleaned thoroughly, even in the parts lying on the borders of, or outside, the surface in contact with the paper web. For this purpose, the surface of the elastomeric insert of the presser is made with a special low-relief configuration which improves the mechanical cleaning action and which has recessed channels which retain some of the cleaning liquid to ensure that it acts efficiently on the dirt to be removed. The shape of the low-relief surface of the presser is also such that it exerts oblique thrust components, which facilitate the removal of what are known as format lines from the cylinder. With a device of this kind, the cleaning cycle of a cylinder is executed by a single stage of positioning a portion of cloth on the said cylinder. At the end of the cycle, the device moves away from the clean cylinder, and means are provided to transfer all or some of the portion of cloth which was previously positioned in front of the row of cleaning liquid spraying nozzles on to the elastomeric presser, in such a way that the device is prepared for the next operating cycle.

The following limitations and drawbacks are encountered in this type of equipment. The spraying of the cleaning liquid on to the cloth does not necessarily have to take place continuously, since the said cloth, with its porous and uniformly distributed structure, has the capacity to act as a buffer for the liquid and to distribute it uniformly even if the liquid is distributed intermittently and therefore in smaller and more controlled amounts than those obtainable with continuous distribution.

The channels of the low-relief surface of the presser are characterized by a constant width throughout their depth, and therefore the projecting parts of this surface are deformed when the cloth is pressed on to the cylinder to be cleaned, these parts tending to close the said channels and adversely affect the operation of the whole equipment, especially in the cleaning of cylinders which are heavily soiled with paper particles. Also in the prior art, the channels of the low-relief surface of the presser are closed on the rear surface, and this condition has been shown to adversely affect the operation of the device since the sprayed liquid tends to remain in place for too long and to accumulate on the presser, with the risk of forming localized drops and/or clumps of dirt which may tear the paper web when they subsequently come into contact with it.

The invention is intended to overcome these drawbacks of the known art, by giving the low-relief part of the presser a novel shape which provides uniformly distributed and very capacious channels which the cloth can enter together with the dirt, in such a way that the dirt can be collected and accumulated in large quantities, the said channels being characterized by a shape which originally diverges outwardly, in such a way that they remain open even after the deformation of the presser in contact with the cylinder to be cleaned, this shape being such that, in the subsequent stage of advance of the cleaning cloth, the portion of the said cloth can easily emerge without abnormal stresses from the said recessed channels of the presser, taking with it all the collected dirt and removing it. The channels are also open on their rear faces, in such a way that the detergent liquid and the dirt not retained by the active surface of the presser pass freely to the paper web for removal, reaching the web with uniform distribution.

In printing machines which operate on a vertically positioned paper web which moves upwards, the cleaning devices are positioned in the quadrants between 12 and 3 o'clock and 12 and 9 o'clock on the two opposing cylinders of the continuous printing system, in such a way that the portion of the surface of the cylinder downstream of the said cleaning devices is of considerable length, enabling the cleaning liquid to remain for a long time on the cylinder and thus improving its capacity to act on the dirt before it comes into contact with the paper web. Trays are positioned under the devices in such a way that, when the said devices are removed from the cylinders, the large amount of dirt which has been collected by the portion of cloth interacting with the presser falls from the said cloth and is collected in the said trays, leaving the cloth in a suitable condition for a repetition of the operating cycle. Clearly, all these conditions enable the cloth to be exploited more thoroughly than it is in the known art, thus significantly reducing the running costs of the equipment and considerably improving the reliability of the process. The improvements in question can also be applied advantageously to continuous printing machines which operate on a horizontally positioned paper web.

Further characteristics and advantages of the invention will be revealed more fully in the following detailed description, provided by way of example and without restrictive intent, with reference to the attached drawings, in which:

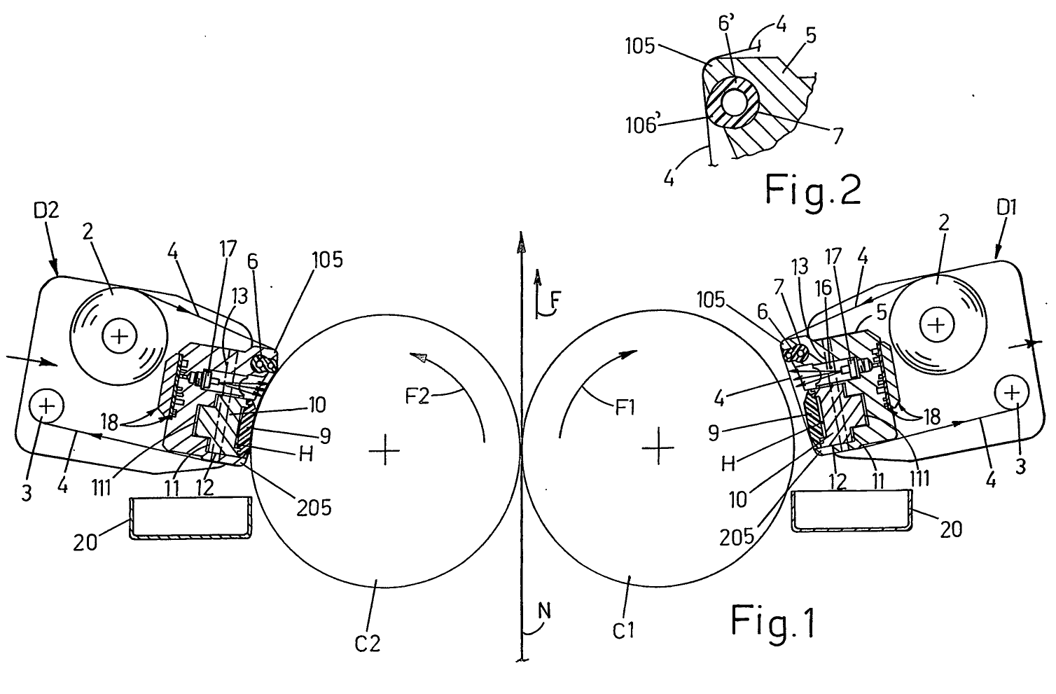

FIG. 1 shows the equipment from the side, in partial section, and represented with the right-hand cleaning device in the rest position and with the left-hand device in the active position in which it operates on the corresponding rubber cylinder of a continuous printing machine operating on a vertically positioned paper web;

FIG. 1a shows the equipment from the side, in partial section, and represented with the upper cleaning device in the rest position and with the lower device in the active position in which it operates on the corresponding rubber cylinder of a continuous printing machine operating on a horizontally positioned paper web;

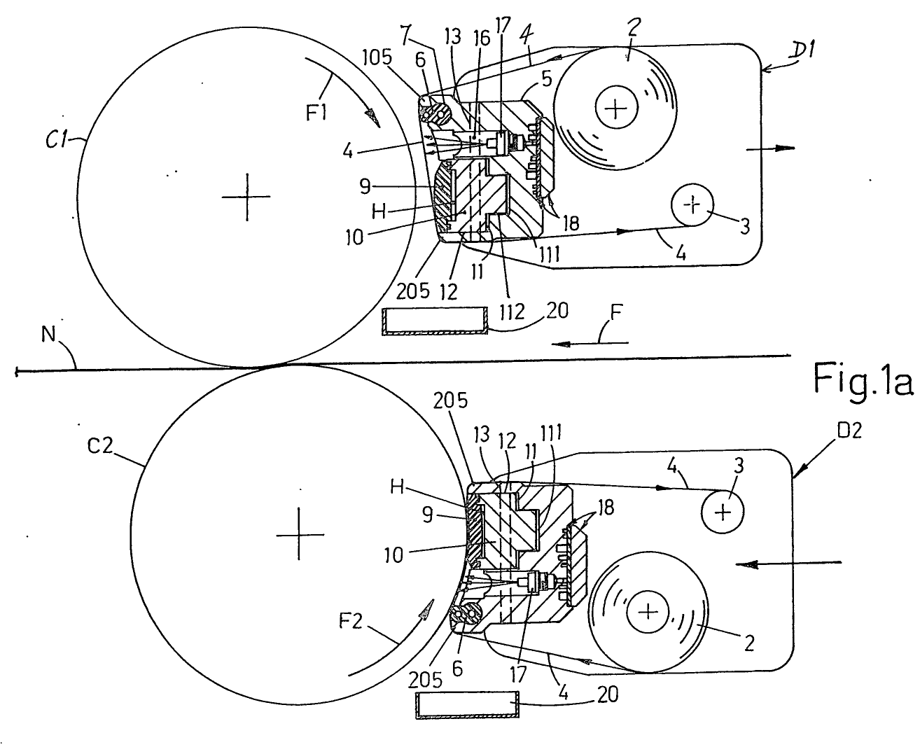

FIG. 2 shows a cross section through a variant embodiment of the elastomeric strip of the devices constituting the equipment in question;

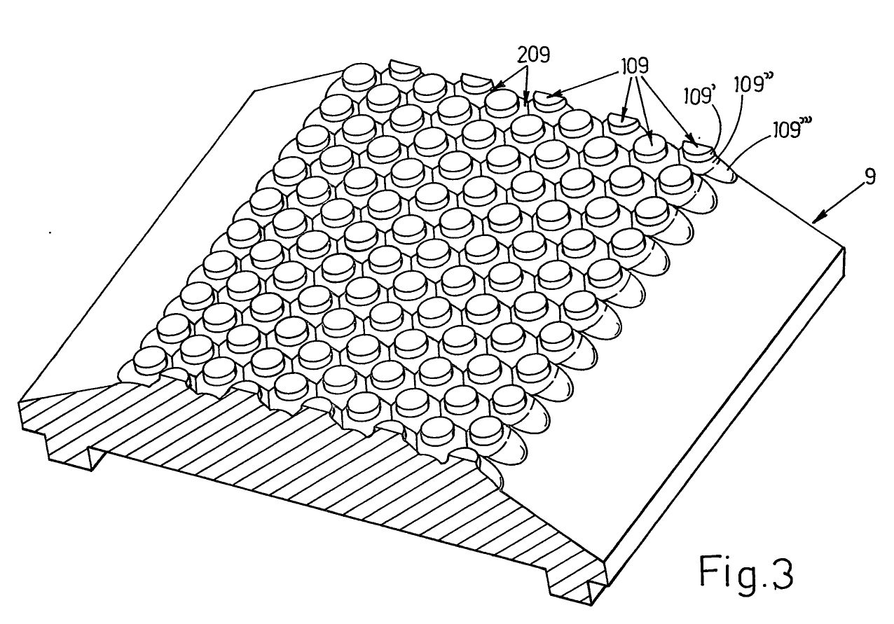

FIGS. 3 and 4 are, respectively, a perspective view and a front elevation of the elastic membrane of the presser, showing its active surface;

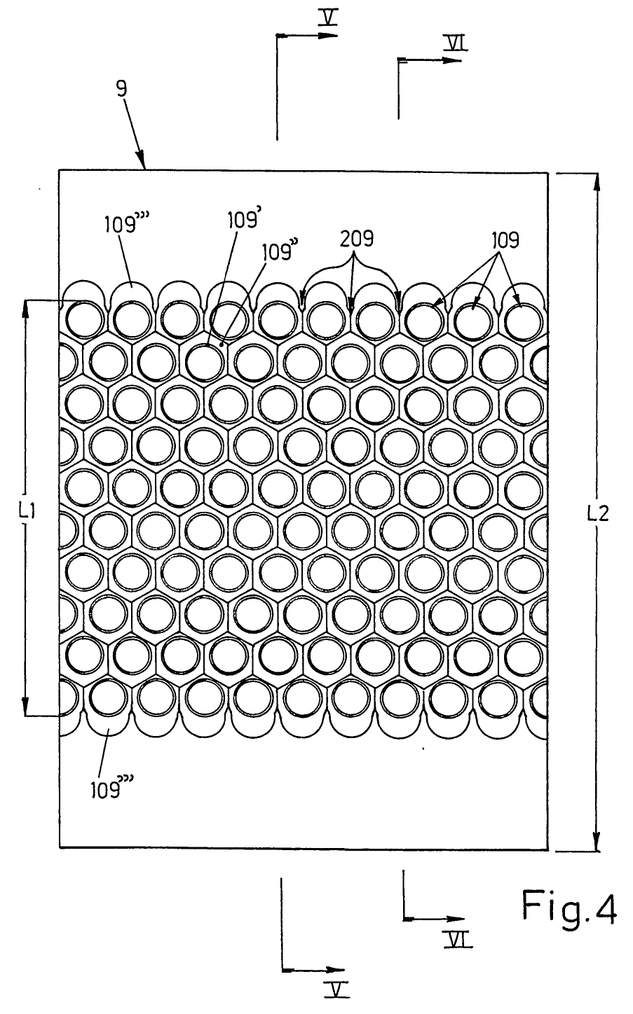

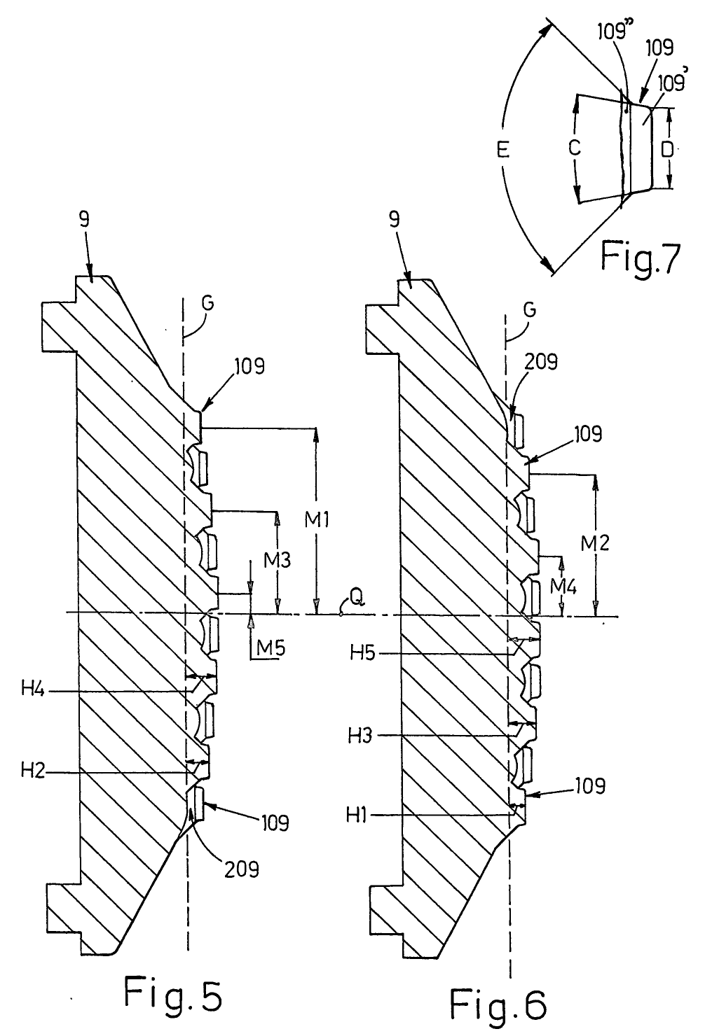

FIGS. 5 and 6 show two details of the elastic membrane of FIG. 4, in section along the lines IV-IV and V-V;

FIG. 7 shows an enlarged lateral elevation of one of the projecting parts of the elastic membrane of the presser shown in the preceding figures.

In FIG. 1, the references C1 and C2 indicate the rubber printing cylinders which rotate in the directions indicated by the arrows F1 and F2 respectively, and which operate in contact with the continuous paper web N which advances approximately vertically, for example in the upward direction, as indicated by the arrow F. D1 and D2 indicate the devices for cleaning the cylinders C1 and C2, constructed and positioned as mirror images of each other and designed in such a way as to be able to act substantially on the whole length of the cylinders or in any case on a length including the areas outside the portion in contact with the paper web N. The cleaning device D1 is preferably positioned on the cylinder C1 in the quadrant lying between 12 and 3 o'clock, preferably at approximately 2 o'clock, while the cleaning device D2 is positioned on the cylinder C2 in the quadrant lying between 9 and 12 o'clock, preferably at approximately 10 o'clock. Each cleaning device comprises a pair of parallel shoulders 1, on which the reels 2 and 3 for feeding and collecting the cleaning cloth 4 are mounted rotatably by means of their shafts, the reels being controlled by suitable braking and feed means of the type used in devices for cleaning rubber cylinders of printing machines, the cloth being run around a robust bar 5 which has ends fixed to the said shoulders 1 and which is such that it projects suitably from these shoulders with a longitudinal portion facing the cylinder to be cleaned and parallel to this cylinder. The shoulders 1 of the devices are mounted on the shoulders (not shown) of the printing machine, using means, known to persons skilled in the art, which on command move the bar 5 in a parallel way towards and away from the cylinder to be cleaned (see below). When the device is in the rest position, as indicated by D1, with the bar 5 at a suitable distance from the rubber cylinder, the cloth 4 is run with a correct tension around the rounded edges 105 and 205 of the front surface of the bar 5, which has a concave profile, and the reels 2 and 3 are braked. The portion of cloth in tension between the edges 105 and 205 of the bar 5 also comes into contact with a rectilinear strip 6 of a suitable elastomeric material, having a cross section in the form of a figure eight or a simple annular cross section as indicated by 6′ in FIG. 2, with a suitable thickening 106′ on the part outside the recess 7 which houses the strip in question, which engages the whole length of the bar 5 and which is parallel and close to the edge 105. At the opposite edge 205, the cloth 4 comes into contact with the lower part of the elastomeric membrane 9 of a presser parallel to the said edge, the supporting body of which consists of a cross-piece 10, having a T-shaped profile for example, housed with correct bottom clearances 11, 111 in corresponding rectilinear seats 12, 112 formed in the concave surface of the bar 5. The membrane 9 has a convex external profile (see below), and is, for example, fixed in a known way on the perimetric edge of the chamber H of a cross-piece 10 which can be fixed to the bar 5 by at least one pair of pins 13 which pass through corresponding holes 14 in the thickest part of the said cross-piece and through holes 15 in the bar 5, and which are housed securely in the last-mentioned holes. The pins 13 have a symmetrical arrangement, and, because of this arrangement and the elastic characteristics of the membrane 9 and of the chamber H, sealed for example, positioned behind it, the said presser is made to exert a uniformly distributed pressure on the portion of the cylinder with which it comes into contact.

Between the parts 6 and 9 and parallel to these, on the concave surface of the bar 5, there is formed a row of seats 16 and/or a corresponding continuous rectilinear chamber, which houses a row of spraying nozzles 17 which are orientated towards the cloth 4, are kept at a suitable distance behind the cloth, and are connected in the rear parts to a fluid distribution circuit 18, supplied by a single line and by a circuit which uses pressurized air as the medium for conveying the cleaning liquids, the whole being arranged in such a way as to enable very small quantities of these liquids to be sprayed in a finely measured and uniformly distributed way on to the whole portion of cloth 4 subjected to the action of the various nozzles 17.

In a preferred embodiment of the invention, each device is designed in such a way that the portion of cloth between the strip 6 and the presser 9 has substantially the same length as the portion of cloth positioned in front of the said presser 9, and in such a way that the combined length of these two portions of cloth is, for example, approximately five centimetres.

The equipment designed in this way operates in the following manner. When the devices D1 and D2 are in the rest position, after each operating stage, the reels 2 and 3 are operated to transfer a clean and uniformly stretched portion of cloth 4 between the members 6 and 9 (see below). When the devices D1 and D2 are activated, they are brought towards the corresponding cylinder to be cleaned, along a path whose length is such that the portion of cloth which is in contact with the strip 6 comes into contact with the rubber cylinder, causing only a slight deformation of the said strip 6. The portion of cloth between the strip 6 and the presser 9 remains under tension and adapts itself uniformly to the curved surface of the rubber cylinder, while the said presser 9 is deformed elastically to push a corresponding portion of cloth, uniformly and with the correct pressure, on to the said cylinder to be cleaned. While the device is brought towards the rubber cylinder, the nozzles 17 start to spray very small quantities of cleaning liquids, continuously or intermittently, and with uniform distribution on to the said cloth, so that, when the cloth 4 comes into contact with the cylinder, the said cloth is already lightly moistened and conveniently lubricated. The cleaning liquid flows in minimal controlled quantities from the cloth to the cylinder, to react immediately with the surface dirt which is then removed by the contact of the said cylinder with the paper web N. The devices remain in the active position for the time required to clean the cylinders C1 and C2, using throughout the cycle the same portion of cloth which has been initially positioned in front of the corresponding bars 5. The pressure exerted by the pressers 9 on the corresponding portion of cloth 4, and consequently on the cylinders to be cleaned, must be such as to provide a sufficiently thorough cleaning action on the said cylinders, with the removal of what are known as format lines, and must simultaneously be such that the dirt fluidized by the very small uniformly distributed quantities of cleaning liquid is made to pass beyond the said presser to arrive, in uniformly distributed form, on the paper web which absorbs and removes it.

Some of the dirt on the cylinders, which consists mainly of paper particles, is retained by the portion of cloth which interacts with the pressers 9, the surface of the said pressers designed to contact the cloth 4 being characterized by a low relief configuration, with solid areas 109 suitably staggered with respect to each other and designed for contact with the cloth, and with areas 209 having a sinuous configuration, which are recessed and do not contact the cloth, and which form true channels of suitable depth, into which the cloth is forced by the thrust of the solid dirt which accumulates on these portions of the cloth not in contact with the solid parts 109. The transverse staggering of the areas under pressure 109 is such that the moving cylinder is contacted by these areas, with the interposition of the cloth, in a uniform way over its whole length.

To promote the entry of the cloth into the recessed channels 209 of the pressers, to facilitate the self-compacting of the dirt on the portions of cloth which occupy these channels, and to facilitate the disengagement and extraction of these portions of cloth with the dirt from the said channels, when the device is removed from the cylinder (see below), the channels 209 in the active surface of the presser 9 have been shaped in a configuration which diverges suitably towards the outside, this also ensuring that, following the elastic deformation of the said surface of the presser in contact with the cylinder to be cleaned, the said channels remain conveniently open.

FIGS. 3 to 7 show that the useful width L1 of the active area of the presser 9 is, for example, approximately 25 mm, compared with a total width L-2 of the said presser which is, for example, approximately 42 mm. The projecting parts 109 of the active surface of the presser 9 come into contact with the cloth with flat round studs each having a diameter D of approximately 2 mm, spaced at equal intervals with a centre distance B of approximately 3 mm and positioned in a plurality of rows aligned with the longitudinal axis of the presser, for example in ten rows parallel to each other and staggered by half a step, in such a way that the round studs of one row are placed in the empty space lying between two consecutive studs of the adjacent rows, the width of this empty space being less than the width of each stud, so that all the studs of the projecting parts 109 act on the rubber cylinder in a uniform way over the whole width of the area to be cleaned. As a result of the said staggering of the longitudinal rows of the projecting parts 109, these parts are also aligned with each other in oblique rows, for example with an inclination A of approximately 30° to the transverse axis of the presser.

The detail in FIG. 7 shows that each projection 109 is formed by a small truncated conical point 109′ having an extraction angle C of approximately 20°, positioned on a base projection 109″ which is also of truncated conical shape, with an extraction angle E of 90°. The base projections 109″ meet each other in a substantially hexagonal pattern, except for the outer rows of projections (FIGS. 3 and 4) which meet the inclined sides of the membrane 9 in a substantially semi-elliptical shape 109′″. In FIGS. 5 and 6, the broken lines and the letter G indicate the theoretical reference plane with respect to which the outer rows of projections 109 are characterized by a distance H1 of, for example, 1 mm. Owing to the convex shape of the active surface of the membrane 9, this distance increases progressively towards the central row, the progression being H2=1.4 mm, H3=1.7 mm, H4=1.9 mm, H5=2 mm, with a decrease forming a mirror image towards the other row. Also in FIGS. 5 and 6, the letter Q indicates the mid-line plane of the membrane 9 with respect to which the rows of projections are characterized by having an increasing distance from the centre towards the exterior, with the following progression: M5=1.3 mm, M4=3.9 mm, M3=6.5 mm, M2=9.09 mm, M1=11.69 mm, and with spacings forming a mirror image for the rows of projections positioned on the other side of the mid-line plane Q.

To facilitate the removal of the dirt which tends to accumulate in the portion of cloth which interacts with the presser and which remains trapped in the channels with the diverging configuration 209 of the said presser, the devices D1 and D2 can be pushed against the corresponding cylinders with a constant and/or suitable variable modulated pressure. When the cylinders have been cleaned, the devices D1 and D2 are moved away from the corresponding cylinders, and, by the action of gravity and/or a suitable longitudinal tension to which the cloth 4 is subjected, the portion of this cloth positioned in front of the membrane 9 of the presser emerges easily from the channels of this membrane and drops all the dirt retained previously into a tray 20 positioned under each device D1, D2, which is periodically emptied or which is automatically cleaned by suitable means.

The cleaning devices D1 and D2 can execute the next cleaning cycle without the longitudinal movement of the cloth 4, to enable the said cloth to be used as thoroughly as possible, subject to its mechanical strength. Only after a predetermined number of cycles, when the devices are in the rest position, the cloth 4 is made to advance longitudinally by a small amount, so that the portion of cloth which was previously in front of the presser 9 is removed and replaced wholly or partially by the portion which was previously in front of the nozzles 17 which are now inactive, for example by means of a movement of approximately 25 mm. Clearly, if the cylinders are particularly dirty and/or if they are cleaned without any contact between the cylinders and the paper web N, a cleaning cycle can comprise a plurality of successive stages of moving the said devices D1 and D2 towards and away from the cylinders, without the advance of the cloth 4, the whole being arranged in a way which will be understood and easily implemented by persons skilled in the art.

The means described above can also be applied, with the same application procedure or different procedures, in continuous printing machines of the type shown in FIG. 1a, operating on a paper web N which is positioned substantially horizontally. In this case, the device D1 can, for example, be positioned in the quadrant of the cylinder C1 lying between 1 and 3 o'clock, while the device D2 can be positioned in the quadrant of the cylinder C2 lying between 3 and 5 o'clock, the whole being arranged in way which will be understood by persons skilled in the art. Any other positioning of the devices D1 and D2 is possible, provided that the necessary spaces are present and that the presser 9 acts on the cylinders C1 and C2 downstream of the portions of the said cylinders which are wetted in advance by the cleaning liquid supplied by the nozzles 17.

1. Equipment for cleaning the rubber cylinders (C1, C2) of continuous printing machines, characterized in that it comprises means (17, 18) for causing a very small quantity of liquid for cleaning the said cylinders to be sprayed in a controlled and uniformly distributed way on to a sufficiently long portion of cloth, which, including the area directly acted on by the said sprayed liquids, is kept in uniform and distributed contact with a transverse portion of the surface of the cylinder to be cleaned, and which is pushed into close and uniformly distributed contact with the rotating cylinder, upstream and downstream of this portion, by a rectilinear deformable strip (6) and by a rectilinear deformable presser (9) respectively, each of these having a convex surface facing the cylinder, the whole being arranged in such a way that the cleaning liquid acts through the cloth on the cylinder to be cleaned in an extended, uniform and progressive way, and in very small quantities, and in such a way that the liquid is conveniently retained in the cleaning area by means of the said cloth and the said rectilinear pushing elements, so that it does not fall off and so that it is transferred to the dirt on the cylinder in a gradual and controlled way, while the presser (9) facilitates the penetration of the liquid into the direct and promotes the elimination and removal of the said dirt by its contact surface which is characterized by a low-relief configuration, to provide better distribution of the cleaning liquid, to provide a better mechanical action for cleaning the cylinder and to enable a large quantity of the paper particles, which constitute the dirt removed from the cylinder, to be retained in its channels.

2. Equipment according to claim 1, in which the deformable presser (9) comprises an elastomeric membrane with a profile substantially in the form of an isosceles trapezium or reducible to this, whose longer base is fixed perimetrically and with a seal to the edge having a conjugate profile of the chamber (H) of a cross-piece (10) fixed on the said equipment, the shorter base of the said membrane being characterized by a profile which is originally slightly convex in the direction of the cylinder to be cleaned and being characterized by the said low-relief shape.

3. Equipment according to claim 1, characterized in that the low-relief shape of the active surface of the presser (9) comprises solid areas (109) designed to come into contact with the cloth and comprises recessed areas (209) arranged in a sinuous pattern, which form true channels of suitable depth, into which the cloth penetrates under the pressure of the solid dirt which accumulates on these portions of cloth not in contact with the said solid parts (109), the said channels (209) being characterized by a shape which is originally suitably outwardly diverging, so that, following the elastic deformation of the said surface of the presser in contact with the cylinder to be cleaned, the said channels remain conveniently open, to allow the cloth and the dirt to enter them and become self-compacted in them and then to emerge from the said channels easily when the whole equipment is removed from the clean cylinder at the end of the cycle.

4. Equipment according to claim 3, in which the projecting parts (109) of the active surface of the presser (9) contact the cloth (4) by means of small round studs which are spaced at equal intervals in a plurality of rows aligned with the longitudinal axis of the presser (9), the rows being parallel to each other and staggered by half a step, in such a way that the studs of one row are positioned in the empty space lying between two consecutive studs of the adjacent rows and the width of this empty space being made to be less than the width of each stud, in such a way that the various studs of the projecting parts (109) are made to act jointly on the rubber cylinder in a uniform way, over the whole width of the area to be cleaned.

5. Equipment according to claim 4, in which the number of longitudinal rows of projecting parts (109) of the elastic membrane (9) of the presser is, for example, ten.

6. Equipment according to claim 4, in which the projecting parts (109) of the active surface of the presser (9) are also aligned with each other in oblique rows, for example with an inclination (A) of approximately 30° to the transverse axis of the said presser, and each oblique row comprises ten projections (109).

7. Equipment according to claim 3, in which each of the projecting parts (109) of the active surface of the presser (9) is formed by a point (109′) of truncated conical shape, with an extraction angle (C) of approximately 20° and a base which is also of truncated conical shape (109″) and has an extraction angle (E) of approximately 90°, the bases of the various projecting parts being joined together to form hexagonal patterns similar to those of a honeycomb.

8. Equipment according to claim 3, in which the bases (109″) of the projecting parts (109) in the outer longitudinal rows of the active surface of the presser (9) are joined to this surface by an outer shape which is semi-elliptical in plan view (109′″).

9. Equipment according to claim 1, characterized in that the width (L1) of the low-relief active surface of the elastic membrane of the presser (9) is approximately 25 mm, while the total width of the said membrane is approximately 42 mm.

10. Equipment according to claim 3, in which the round studs of the points of the projecting parts (109) of the active surface of the presser (9), which contact the cleaning cloth (4), are flat, are spaced apart in each row with an interval of approximately 3 mm, have a diameter of approximately 2 mm each and have a height of approximately 0.5 mm.

11. Equipment according to claim 5, in which the projecting parts (109) of the active surface of the presser (9) have their active surfaces at the following vertical distances above a theoretical base plane (G), from the outside towards the centre: H1=1 mm, H2=1.4 mm, H3=1.7 mm, H4=1.9 mm, H5=2 mm.

12. Equipment according to claim 5, in which the longitudinal rows of projecting parts (109) of the active surface of the presser (9) are at the following horizontal distances from a longitudinal mid-line plane (O), from the innermost rows towards the outside:
M5=1.3 mm, M4=3.9 mm, M3=6.5 mm, M2=9.09 mm, M1=11.69 mm.

13. Equipment according to claim 1, characterized in that it comprises at least one robust rectilinear bar (5), parallel to each cylinder (C1, C2) and movable on command towards and away from the cylinder, the ends of the bar being fixed to shoulders (1) which extend away from the cylinder and which support the ends and the means of driving and braking the shafts of reels (2, 3) which are parallel to the said bar and designed to feed and collect the fabric or cloth (4) which runs, with the correct tension, over the front surface of the said bar, which is concave and which is provided, at its suitably rounded upper and lower edges (105, 205) and parallel to these, with a strip (6) and a presser (9) respectively, both of these being rectilinear and made from elastomeric material, the said concave surface of the bar having seats (16) formed at a correct distance from the portion of cloth which is not acted on by the presser (9) and which lies between the presser (9) and the pressure strip (6), these seats having nozzles (17) connected to a distribution circuit (18) and to means for spraying the cleaning liquids on command in a controlled, continuous and uniformly distributed way, so that when the equipment in question is brought towards the cylinder to be cleaned the portion of cloth lying between the said strip and the presser remains in tension and comes into contact uniformly with a corresponding portion of the dirty surface of the cylinder, while both the strip and the presser are deformed elastically in contact with the cylinder through the cloth, to retain the cleaning liquids and to prevent these from falling from the working area.

14. Equipment according to claim 13, characterized in that it is designed in such a way that the length of the portion of cloth positioned in front of the active surface of the presser (9) is substantially equal to the length of the portion of cloth positioned in front of the row of nozzles (17) for spraying the cleaning liquid and lying between the said presser and the elastomeric strip (6).

15. Equipment according to claim 13, in which the pressure and sealing strip (6) is formed by a tubular rubber section having a profile substantially in the shape of a figure of eight, partially housed in a suitable rectilinear recess (7) formed in the front concave surface of the bar (5), and partially projecting from this recess to contact the said cloth (4).

16. Equipment according to claim 13, in which the pressure and sealing strip (6) is of the simple type, with a single cavity and having a continuous longitudinal thickening (106′) in the part designed for contact with the cloth (4).

17. Equipment according to claim 2, in which the cross-piece (10) which supports the elastomeric membrane (9) of the presser which acts on the cloth (4) downstream of the area in which the cleaning liquids is sprayed is mounted in a seat (12, 112) formed in the movable bar (5) of the said equipment with correct bottom clearances (11, 111) and by means of at least one pair of pins (13) positioned symmetrically in such a way that the said presser is made to exert a uniformly distributed pressure on the cylinder to be cleaned.

18. Equipment according to claim 1, characterized in that, in order to clean the opposing cylinders (C1, C2) of a continuous printing machine which operates on a continuous paper web arranged in a substantially vertical way and running, for example, in an upward direction, the said equipment comprises at least one corresponding device (D1, D2) of the type in question, arranged as mirror images of each other, in the quadrant lying between 12 and 3 o'clock for the right-hand cylinder and in the quadrant lying between 12 and 9 o'clock for the left-hand cylinder, means being provided to keep the cleaning devices in the active position of interaction with the cylinders while the cylinders remain active and in contact with the continuous paper web (N) which is used as the means for removing and eliminating the dirt softened by the said devices, the said devices being made to be removed from the said cylinders on completion of the cleaning of the cylinders, in such a way that the dirt collected by the portion of cloth positioned in front of the presser (9) and the residual liquid fall into a tray (20) positioned under each cleaning device and designed so that it can be cleaned in its turn.

19. Equipment according to claim 18, in which means are provided to cause the cleaning devices (D1, D2) to be carried in successive active movements of interaction with the corresponding cylinders (C1, C2) without substantially modifying the position of the cloth (4) in front of the corresponding presser (9), in such a way that the said cloth is used thoroughly, in a way compatible with its resistance to wear, means being provided to cause the cloth (4) of each cleaning device to be made to advance longitudinally only after a plurality of operating cycles, to remove the part of the cloth positioned in front of the presser (9) and to replace it with the portion of cloth which was previously positioned in front of the nozzles (17) for spraying the cleaning liquids.

20. Equipment according to claim 19, in which means are provided to cause the portion of cloth lying between the feed reel (2) and the collection reel (3) to be brought to the correct longitudinal tension when the cleaning devices are moved away from the corresponding cylinders, to facilitate the detachment of the dirt from the cloth.

21. Equipment according to claim 18, in which the means which keep the cleaning devices (D1, D2) in the active position of interaction with the cylinders to be cleaned are such that a continuous and/or variable modulated pressure is provided to the said devices.

22. Equipment according to claim 1, characterized in that it can also be used for cleaning the cylinders of continuous printing machines which operate on a paper web arranged in a substantially horizontal way, the cleaning device (D1) which acts on the upper cylinder (C1) being positioned in this case in the quadrant of this cylinder lying between 1 and 3 o'clock, while the lower cleaning device (D2) is, for example, positioned in the quadrant of the lower cylinder (C2) lying between 3 and 5 o'clock.

23. Equipment according to claim 1, characterized in that, for cleaning cylinders which are particularly dirty or between which the paper web (N) is not to be passed to remove the dirt, means can be provided to cause the said cylinders to be cleaned with a number of movements of the corresponding cleaning devices (D1, D2) towards and away from the cylinders.
